(19) United States
(12) Patent Application Publication
(10) Pub. No.: US 2024/0217252 A1
(43) Pub. Date: Jul. 4, 2024

(54) USE OF N-(P-TOLUOLSULFONYL)-N'-(3-P-TOLUOLSULFONYL-OXY-PHENYL)UREA AS A COLOR DEVELOPER IN A HEAT-SENSITIVE RECORDING MATERIAL

(71) Applicant: KOEHLER INNOVATION & TECHNOLOGY GMBH, Oberkirch (DE)

(72) Inventors: Michael HORN, Offenburg (DE); Timo STALLING, Appenweier (DE); Maren STEPPAT, Oberkirch (DE)

(21) Appl. No.: 17/913,765

(22) PCT Filed: Mar. 19, 2021
(86) PCT No.: PCT/EP2021/057129

§ 371 Date: Sep. 22, 2022

(30) Foreign Application Priority Data
Mar. 23, 2020 (DE) 20164949.8

(51) Int. Cl. B41M 5/323; B41M 5/333; B41M 5/42; C09D 11/03

(52) U.S. Cl. CPC B41M 5/323; B41M 5/3333; B41M 5/42; C09D 11/03

(57) ABSTRACT

Use of N-(p-toluenesulfonyl)-N′-(3-p-toluenesulfonyl-oxy-phenyl)urea with an X-ray diffraction pattern with Bragg angles (2θ/CuK_{α}) of 10.3, 11.0, 12.9, 13.2, 15.4, 17.1, 18.0, 18.2, 19.4, 20.0, 20.7, 21.2, 23.0, 24.9, 25.3, 26.5, 26.8, 27.5, 30.7, 32.7 as a colour developer in a heat-sensitive recording material comprising a carrier substrate, a heat-sensitive colour-forming layer which is applied to one face of the carrier substrate and which contains at least one non-phenolic colour developer and at least one colour former, and an adhesive layer and/or a coating in order to allow rear-face printing using conventional printing methods on the carrier substrate face facing away from the heat-sensitive colour-forming layer, so as to limit the loss of image density and/or the relative print contrast and/or the reduction of the area-based colour developer quantity, wherein, with a value of ≥1.20 optical density units for the heat-sensitive recording material stored in accordance with the migration test defined in the description, the image density equals at least 35% of the value of the image density prior to storage and/or the relative print contrast of the heat-sensitive recording material stored in accordance with the migration test equals at least 70% of the value of the relative print contrast prior to storage and/or the area-based colour developer quantity of the heat-sensitive recording material stored in accordance with the migration test equals at least 30% of the area-based colour developer quantity prior to storage.

The present invention relates to the use of N-(p-toluenesulfonyl)-N′-(3-p-toluenesulfonyl-oxy-phenyl)urea as a colour developer in a heat-sensitive recording material, wherein the heat-sensitive recording material comprises a carrier substrate, a heat-sensitive colour-forming layer which is applied to one face of the carrier substrate and which contains N-(p-toluenesulfonyl)-N′-(3-p-toluenesulfonyl-oxy-phenyl)urea as at least one non-phenolic colour developer and at least one colour former, and a so-called back-coat preparation applied to the face opposite the carrier substrate face carrying the heat-sensitive layer, with the objective of limiting the loss of heat-induced writing performance after long-term storage of the thermally non-printed recording material.

Back-coat preparations are used in conjunction with heat-sensitive recording materials to obtain self-adhesive labels (thermal labels) or to improve various application properties. Specifically, the back-coat preparation can be a self-adhesive layer or a coating (back-coat) consisting substantially of polymeric binders and pigments.

Heat-sensitive recording materials (so-called thermal labels) equipped with a self-adhesive layer on the rear face for direct thermal printing are known from the prior art.

Documents JPS59162087A, U.S. Pat. Nos. 4,370,370A and 4,388,362A describe thermal labels having a release paper.

Document DE19757589B4 describes a release-paper-free (“linerless”) thermal label having a protective layer over the heat-sensitive layer.

Document DE19806433B4 discloses a linerless thermal label having a protective layer which is free from silicone compounds and which has been cured by means of actinic radiation.

Documents EP0600622A1 and DE19724647C1 describe a linerless thermal label which has a protective layer and which has been coated on the rear face with hotmelts.

Documents EP1085069B1 and EP2474963B1 disclose thermal label materials in a linerless embodiment with a heat-activatable adhesive, wherein thermal labels both with and without a protective layer are described.

Document EP 3219507A1 claims a linerless thermal label without an actual protective layer, in which the surface of the heat-sensitive layer has been made non-adherent to adhesives.

Heat-sensitive recording materials equipped with so-called “back-coat” coatings to improve the printability on the rear face using conventional printing methods or to minimise the curling of a carrier substrate under unfavourable moisture conditions are also known from the prior art.

Thus, the different shrinkage behaviour of the two sides of the carrier substrate of heat-sensitive recording materials at different ambient humidity (different water vapour absorption of the two sides/coats) can be effectively improved by back-coatings. For example, document U.S. Pat. No. 6,667,275B2 discloses a multi-layer back-coating for heat-sensitive recording materials to advantageously influence the curling of the web of the substrate.

Document JP2018167483 discloses ways to improve the resistance of the thermally produced print of heat-sensitive recording materials which have been exposed to oil-based inks or printing inks on the rear face by, among other things, applying coatings to the rear face. Often, the formulations of these back-coatings contain aqueous emulsion polymers, such as SB or acrylate latices, as an essential component.

Document JP2003175671, for example, claims back-coatings prepared with aqueous latices for heat-sensitive recording materials that form soft polymer films (Tg)≥−30°. Documents JPH0720735B2 and JP2000204123 disclose back-coat formulations with acrylate emulsion polymers for heat-sensitive recording materials.

In the colour-forming layer of heat-sensitive recording materials, there is usually a colour former and a colour developer which react with each other under the influence of heat and thus lead to colour development. Cost-effective phenolic colour developers (bisphenol A, bisphenol S, etc.) are widely used. With these, thermal labels can be obtained that have an acceptable performance profile for certain applications.

Thermal labels that contain a non-phenolic colour developer in the heat-sensitive colour-forming layer are also known from the prior art. These were developed to improve the durability of the print, especially if the printed heat-sensitive recording material comes into contact with hydrophobic substances, such as plasticised substances and materials or oils. In addition to the technical advantages, public discussions about the toxic potential of (bis)phenolic chemicals especially have greatly stimulated interest in non-phenolic colour developers.

Storage of thermally non-printed (“white”) self-adhesive thermal labels or heat-sensitive recording materials provided with back-coatings over longer periods of time, especially at elevated ambient temperature and/or humidity, may result in deteriorations of application-related properties. Especially, heat-sensitive recording materials provided with such back-coat preparations may no longer reach the specified values of the degree of blackness of the printout (for example the barcode or the lettering) or the surface whiteness after storage. However, a low degree of blackness of the printout generally leads to a reduction in the reading contrast and is additionally worsened by the drop in the background whiteness. Since the readability of barcodes, for example, is especially important for label applications, low contrast values have a negative effect on this essential application-related property. The cause of this phenomenon is considered to be the adhesive layer on the rear face and/or the back-coating, from which substances migrate through the carrier substrate into the chemically reactive heat-sensitive recording layer over the course of the storage time and interact with the components essential for the colour-forming reaction, especially with the colour developer, in a way that is harmful for the subsequent thermal printing process. The greatest contribution to the migration problem is made by substances with relatively low molar mass (<10 kDa). The deterioration of performance after storage may also occur if a heat-activatable adhesive, i.e. one that is solid at room temperature, is used.

Especially, colour developers which have more complex chemical structures than structurally relatively simple (bis)phenols and which have a large number of reactive sites in the molecule, as is generally the case with non-phenolic colour developers, but especially with sulfonylurea colour developers (SU developers), such as N-(p-toluenesulfonyl)-N′-(3-p-toluenesulfonyl-oxy-phenyl)urea, may be affected by the problem of undesirable interaction with substances that may be released from the heat-sensitive recording materials equipped with a back-coat preparation.

To ensure, within the adhesive layer, cohesive strength of pressure-sensitive adhesives and adhesive strength (adhesion) to the substrate, typical pressure-sensitive adhesive formulations use non-polymeric tacky resins (for example natural or carbon resins) and/or plasticisers, tackifiers and possibly other small-molecule additives, such as crosslinkers, stabilisers, etc., in addition to a base polymer.

If it is taken into account that the base polymers contain residual monomers or oligomers from the synthesis process and can form further monomers due to the hydrolytic degradation favoured at high ambient humidities and temperatures, the migration potential of small-molecule substances inherent to an adhesive layer can be easily recognised.

The same applies for the SB and acrylate latices frequently used as binders or barrier agents in back-coatings and produced by emulsion polymerisation.

In addition to the above-described possibilities of the presence of residual monomers in the latex, the presence of typical process-related substances, such as surfactants, soaps, and initiators, during emulsion polymerisation must be taken into account when evaluating the migration potential of the polymeric components of the back-coatings.

The prior art offers different solutions to this problem for adhesive thermal labels: The application of an additional layer between the rear face of the carrier substrate and the adhesive layer (so-called back-coat), as described in documents U.S. Pat. No. 4,370,370A and EP2474963B1, or the incorporation of special substances, for example carboxylated polyvinyl alcohols, into the adhesive layer, as described in document JPS59162087A.

These solutions, however, are economically disadvantageous as they require additional production steps and make the label material more complex overall; they are only able to minimise the migration problem of back-coatings if they utilise more costly, low-migration binders.

The aim of the present invention was to optimise the property profile of a thermally non-printed heat-sensitive recording material which, on its rear face, carries an adhesive layer and/or a functional coating, especially by improving the minimum durability of the heat-sensitive recording material. In this way, the loss of writing performance during thermal printing after storage is to be limited to the greatest possible extent, especially also if the thermally unprinted heat-sensitive recording material is exposed to a longer storage time.

Writing performance is characterised, among other things, by the relative print contrast and the image density.

It is also intended to limit negative effects on important application-related properties of a self-adhesive recording material (or, for rear-face printing, a recording material equipped with a back-coating), which occur mainly due to the migration of constituents from the adhesive layer, from the back-coating or from the rear-face printing ink under harsh storage conditions.

The inventors have recognised that this disadvantageous migration, especially by substances with relatively low molar mass (<10 kDa), occurs in the following situations:
a) The recording material has a self-adhesive layer on the rear face (migration from the adhesive).
b) The recording material is printed immediately (“directly”) on the rear face (migration from the printing ink).
c) The recording material has a back-coating (migration from this coating). In this case, the recording material does not necessarily have to be printed; migration can also occur through storage in an unprinted state.

Surprisingly, it has now been found that the disadvantages described above can be overcome by using a specific polymorphic form of the non-phenolic colour developer N-(p-toluenesulfonyl)-N′-(3-p-toluenesulfonyl-oxy-phenyl)urea. Especially, the use leads to a limitation of the loss of writing performance after storage, under demanding ambient conditions, of heat-sensitive recording materials provided with back-coat preparations.

This specific polymorphic form of the non-phenolic colour developer N-(p-toluenesulfonyl)-N′-(3-p-toluenesulfonyl-oxy-phenyl)urea is also called the beta form in the following.

Besides the beta form, two other polymorphic forms are known:
1) The alpha form was first described in WO 00/35679 and is also commercially available under the name Pergafast 201 or PF201 as a colour developer for heat-sensitive recording materials.
2) The polymorphic form corresponding to the beta form and another polymorphic form were described for the first time in US 2005/221982 A1. Said document also describes the use of mixtures of the three polymorphic forms as colour developers for heat-sensitive recording materials, as well as heat-sensitive recording materials containing the two further polymorphic forms or the mixture of the three polymorphic forms. The heat-sensitive recording material may also contain other, known colour developers and may be prepared by using at least one colour developer, for example the beta form or the gamma form. The carrier material may have a protective layer, an adhesive layer or a magnetic layer on its rear face. However, the use of the beta-form to address the problem according to the invention was not recognised here, nor is it obvious on the basis of the general disclosure.

The use of the alpha form of the chemical compound N-(p-toluenesulfonyl)-N′-(3-p-toluenesulfonyl-oxy-phenyl)urea (Pergafast 201) as a colour developer is described in document EP 3 109 059 A1.

The above-stated problem is addressed by the use of N-(p-toluenesulfonyl)-N′-(3-p-toluenesulfonyl-oxy-phenyl)urea with an X-ray diffraction pattern with Bragg angles (2θ/CuK_{α}) of 10.3, 11.0, 12.9, 13.2, 15.4, 17.1, 18.0, 18.2, 19.4, 20.0, 20.7, 21.2, 23.0, 24.9, 25.3, 26.5, 26.8, 27.5, 30.7, 32.7 (B-PF201) as a colour developer in a heat-sensitive recording material comprising a carrier substrate, a heat-sensitive colour-forming layer which is applied to one face of the carrier substrate and which comprises at least N-(p-toluenesulfonyl)-N′-(3-p-toluenesulfonyl-oxy-phenyl)urea as non-phenolic colour developer and at least one colour former, and an adhesive layer and/or a coating in order to improve the application-related properties (for example suitability for rear-face printing using conventional printing methods and/or rolling) on the carrier substrate face facing away from the heat-sensitive colour-forming layer, so as to limit the loss of the relative print contrast and/or the image density and/or the reduction of the area-based colour developer quantity, wherein the relative print contrast of the heat-sensitive recording material stored in accordance with the migration test (as defined hereinafter) equals at least 70% and/or the image density, at a value of ≥1.20 optical density units, of the heat-sensitive recording material stored in accordance with the migration test equals at least 35% of the value of the image density prior to storage and/or the area-based colour developer quantity (mg/m²) of the heat-sensitive recording material stored in accordance with the migration test equals at least 30% of the area-based colour developer quantity prior to storage.

The use according to the invention relates especially to the very practically relevant case of a self-adhesive heat-sensitive recording material, that is to say a heat-sensitive recording material which has an adhesive layer on the carrier substrate face facing away from the heat-sensitive colour-forming layer.

The self-adhesive heat-sensitive recording material is preferably removable from a surface or permanently adhesive.

Preferably, the relative print contrast of the papers stored in accordance with the migration test (as defined hereinafter) is at least 80%.

Preferably, the image density, at a value of ≥1.20 optical density units, of the papers stored in accordance with the migration test is at least 40%, especially preferably at least 50%.

Preferably, the area-based colour developer quantity in papers stored in accordance with the migration test is at least 30% of the colour developer quantity before storage.

In the context of the present disclosure, storage means that the heat sensitive recording material is stored for four weeks between two glass plates at 60° C., a pressure of 1350 N/m², a relative humidity of 50% and in the absence of light (migration test).

The migration test (adhesive migration test), the determination of the image density, of the relative print contrast, as well as the quantitative determination of the area concentration of colour former and colour developer are described hereinafter:

### (1) Determination of Whiteness

The whiteness of the face carrying the heat-sensitive coating (=top face) of the thermal label papers was determined according to ISO 2470 using an Elrepho 3000 spectrophotometer.

The % decrease in whiteness after storage was determined using Eq. 1

$$\% remaining whiteness = ( \frac{whiteness after storage}{whiteness before storage} ) * 100 \qquad ( Eq . 1 )$$

### (2) Determination of Image Density:

The image density (optical density, o.d.) was measured using a SpectroEye densitometer from X-Rite, wherein the measurement uncertainty of the o.d. values was estimated at ≤2%. The scatter of the % values calculated according to (Eq. 3) was ≤+2 percentage points.

### (3) Determination of the Relative Print Contrast:

The relative contrast was calculated from the value of the optical density of a thermally printed region (oDₛ) and the optical density of a non-printed region (oD_{w}) according to Eq. (2) (s=black region, w=white region):

$$\% rel . contrast = ( \frac{oDs - oDw}{oDs} ) * 100 \qquad ( Eq . 2 )$$

### (4) Migration Test (Adhesive Migration Test):

An A4 heat-sensitive recording material with an adhesive layer on the carrier substrate face facing away from the heat-sensitive colour-forming layer was divided lengthwise into three strips 6 cm wide. Two strips were stored for four weeks between two glass plates at 60° ° C., a pressure of 1350 N/m², a relative humidity of 50% and in the absence of light, while one strip was printed and measured according to (2) (o.d., image density before storage).

After storage and once brought to room temperature, the two strips were printed according to (2), and the optical density was determined, averaged and set in relation to the analogously determined image density values of the non-stored sample according to the formula (Eq. 2).

$$\% remaining image density = ( \frac{image density after storage}{image density before storage} ) * 100 \qquad ( Eq . 3 )$$

### (5) Quantitative Determination of the Area Concentration of the Colour Former and Colour Developer, Especially the Colour Developer:

The coat components (colour former and colour developer) were quantified after HPLC separation with an Agilent 1200 series HPLC instrument with DAD detector.

Sample preparation: Two circular areas (area 0.000402 m²) were punched out of the paper sample using a punch. The paper samples were extracted with 3 ml acetonitrile (HPLC quality) in an ultrasonic bath for 30 minutes. If the extract was turbid, it was filtered through a 0.45 μm filter. As standard, 10 μl were injected.

HPLC separation of the ingredients: Using an autosampler, the above extract was applied to the separation column (Synergi 4 μm Fusion RP80A, 250×3 mm, preceded by SecurityGuard pre-column with cartridge 4×2 mm) and eluted with the flow agent acetonitrile:H₂O with 0.1% formic acid (60:40 parts by volume) with an acetonitrile (with 0.1% formic acid) gradient.

The quantitative evaluation of the chromatograms was carried out via the area comparison of the sample peaks assigned via t times with a standard curve determined via the reference sample. The measurement error in the HPLC quantification was ±2%.

The preparation of the polymorphic compounds (α and β form) was carried out according to known methods.

Table 1 summarises the most important measurement properties of the investigated polymorphic forms of PF201, including the most intense reflections from the X-ray powder diffractograms (XRPD), characteristic FTIR bands, and melting behaviour (DSC).

TABLE 1

| Colour | | | |
|---|---|---|---|
| developer, | 2 θ values of the most intense XRD | Melting point (° C.), | |
| polymorphic | peaks^{#} | onset (DSC)^{‡} | Characteristic IR bands (cm⁻¹)* |
| Alpha form | 8.5, 9.5, 11.8, 12.1, 12.2, 13.7, 14.1, | 161-162 | 1370 i; 1662 i; 3328 m |
| | 16.6, 17.1, 18.3, 18.6, 19.1, 19.3, | | |
| | 20.1, 20.4, 20.9, 21.3, 23.1, 24.2, | | |
| | 24.6, 25.0, 27.9, 28.6 | | |
| Beta form | 10.3, 11.0, 12.9, 13.2, 15.4, 17.1, | 166-167 | 1383 i; 1682 i; 3345 m |
| | 18.0, 18.2, 19.4, 20.0, 20.7, 21.2, | | |
| | 23.0, 24.9, 25.3, 26.5, 26.8, 27.5, | | |
| | 30.7, 32.7 | | |

^{#}XRD, Bruker D2 Phaser, Cu electrode, 30 kV, Lynxeye detector.
^{‡}Netsch DSC 200 F3 Maia ® instrument, Al crucible with cold-welded, perforated lid, heating rate 10 K/min, 25° C. to 200° C. under N₂ atmosphere.
*FTIR, KBr pressings; i = intense, m = medium.

The choice of the carrier substrate for the heat-sensitive recording material is not critical. However, from an economic and environmental point of view, it is preferred if the carrier substrate comprises paper, synthetic paper and/or a plastics film, especially paper.

If necessary, at least one further intermediate layer (“precoat”) is present between the carrier substrate and the heat-sensitive layer, wherein this further intermediate layer has the task of improving the surface smoothness of the carrier for the heat-sensitive layer and ensuring a heat barrier between carrier substrate and the heat-sensitive layer.

Preferably, organic hollow sphere pigments and/or calcined kaolins are used as pigments in this intermediate layer.

Also, at least one protective layer and/or at least one layer promoting printability may be present in the heat-sensitive recording material according to the invention, these layers being applied over the heat-sensitive layer.

The heat-sensitive recording material can additionally comprise at least one customary protective layer and/or a customary non-stick coating (for example a silicone coating), especially for so-called linerless applications. Here, too, the beta form has proven to be advantageous with regard to a possible migration of substances from these layers. In principle, it can be assumed that the beta form makes the heat-sensitive recording material less sensitive to substances that can migrate from other coatings into the colour-forming layer, especially under usual, sometimes harsh and prolonged storage conditions.

Preferably, at least 80% by weight, especially preferably at least 90% by weight, of the beta form is used as colour developer (in relation to the total amount of colour developer used). Especially preferably, only the beta form is used as colour developer, except for unavoidable impurities.

With regard to the choice of colour former, the heat-sensitive recording material is also not subject to any significant restrictions. Preferably, however, the colour former is a dye of the triphenylmethane, fluoran, azaphthalide and/or fluorene type. A very especially preferred colour former is a dye of the fluoran type, as its availability and balanced application-related properties make it possible to provide a recording material that has an attractive price/performance ratio.

Especially preferred fluoran-type dyes are:
3-diethylamino-6-methyl-7-anilinofluoran,
3-(N-ethyl-N-4-toludinamino)-6-methyl-7-anilinofluoran,
3-(N-ethyl-N-isoamylamino)-6-methyl-7-anilinofluoran,
3-diethylamino-6-methyl-7-(2, 4-dimethylanilino)fluoran,
3-pyrrolidino-6-methyl-7-anilinofluoran,
3-(cyclohexyl-N-methylamino)-6-methyl-7-anilinofluoran,
3-diethylamino-7-(3-trifluoromethylanilino)fluoran,
3-N-n-dibutylamino-6-methyl-7-anilinofluoran,
3-diethylamino-6-methyl-7-(3-methylanilino)fluoran,
3-N-n-dibutylamino-7-(2-chloroanilino)fluoran,
3-(N-ethyl-N-tetrahydrofurfurylamino)-6-methyl-7-anilinofluoran,
3-(N-methyl-N-propylamino)-6-methyl-7-anilinofluoran,
3-(N-ethyl-N-ethoxypropylamino)-6-methyl-7-anilinofluoran,
3-(N-ethyl-N-isobutylamino)-6-methyl-7-anilinofluoran and/or
3-dipentylamino-6-methyl-7-anilinofluoran.

The colour formers can be used as individual substances or as any mixtures of two or more colour formers, provided that the desirable application-related properties of the recording materials do not suffer as a result.

The colour former is preferably present in an amount of from about 5 to about 30, especially preferably in an amount of from about 8 to about 20, in relation to the total solids content of the heat-sensitive layer.

The colour developer used is the non-phenolic colour developer in the polymorphic modification with the highest melting point (polymorph from Table 1=beta form), individually or as a mixture with other polymorphic forms of the same colour developer or with chemically different colour developers.

The amount of colour developer is preferably from about 3 to about 35% by weight, especially preferably from about 10 to about 25% by weight, in relation to the total solids content of the heat-sensitive layer.

The weight ratio of colour developer to colour former is preferably at most 3:1, especially preferably at most 2:1, very especially preferably at most 1:1. Presumably, the beta form can be used in smaller amounts than the alpha form to obtain a heat-sensitive recording material of improved or at least the same quality.

In addition to the at least one polymorphic modification of the colour developer (beta form), one or more sensitising agents, also called thermal solvents, may be present in the heat-sensitive colour-forming layer, which has the advantage of making it easier to control the thermal printing sensitivity.

In general, crystalline substances of which the melting point is between about 90 and about 150° C. and which dissolve the colour-forming components (colour former and colour developer) in the molten state without interfering with the formation of the colour complex are advantageously considered to be sensitising agents.

Preferably, the sensitising agent is a fatty acid amide, such as stearamide, beheneamide or palmitamide, an ethylene-bis-fatty acid amide, such as N,N-ethylene-bis-stearic acid amide or N,N-ethylene-bis-oleic acid amide, a fatty acid alkanolamide such as N-(hydroxymethyl)stearamide, N-hydroxymethylpalmitamide or hydroxyethyl stearamide, a wax such as polyethylene wax or montan wax, a carboxylic acid ester such as dimethyl terephthalate, dibenzyl terephthalate, benzyl 4-benzyloxy benzoate, di-(4-methylbenzyl)oxalate, di-(4-chlorobenzyl)oxalate or di-(4-benzyl)oxalate, an aromatic ether such as 1,-2-diphenoxyethane, 1,2-di-(3-methylphenoxy)ethane, 2-benzyloxynaphthalene or 1,4-diethoxynaphthalene, an aromatic sulfone such as diphenyl sulfone, and/or an aromatic sulfonamide such as benzenesulfonanilide or N-benzyl-4-toluenesulfonamide, or aromatic hydrocarbons such as 4-benzylbiphenyl.

The sensitising agent is preferably present in an amount of from about 10 to about 40, more preferably in an amount of from about 15 to about 25, in relation to the total solids content of the heat-sensitive layer.

In a further preferred embodiment, in addition to the colour former, the phenol-free colour developer and the sensitising agent, at least one stabiliser (anti-ageing agent) for the colour complex is optionally present in the heat-sensitive colour-forming layer.

The stabiliser is preferably constituted by sterically hindered phenols, especially preferably 1,1,3-tris-(2-methyl-4-hydroxy-5-cyclohexyl-phenyl)butane, 1,1,3-tris-(2-methyl-4-hydroxy-5-tert-butylphenyl)butane, and 1,1-bis-(2-methyl-4-hydroxy-5-tert-butyl-phenyl)butane.

Urea-urethane compounds (commercial product UU) or ethers derived from 4,4′-dihydroxydiphenylsulfone, such as 4-benzyloxy-4′-(2-methylglycidyloxy)-diphenylsulfone (trade name NTZ-954, Nippon Soda Co. Ltd.), or oligomeric ethers (trade name D902, Nippon Soda Co. Ltd.) can be used as stabilisers in the recording material according to the invention.

The stabiliser is preferably present in an amount of from 0.2 to 0.5 parts by weight, in relation to the at least one phenol-free colour developer.

In a further preferred embodiment, at least one binder is present in the heat-sensitive colour-forming layer. The binder is preferably constituted by water-soluble starches, starch derivatives, starch-based biolatices of the EcoSphere® type, methyl celluloses, hydroxyethyl celluloses, carboxymethyl celluloses, partially or completely saponified polyvinyl alcohols, chemically modified polyvinyl alcohols or styrene-maleic anhydride copolymers, styrene-butadiene copolymers, acrylamide-(meth)acrylate copolymers, acrylamide-acrylate-methacrylate terpolymers, polyacrylates, poly(meth)acrylic acid esters, acrylate-butadiene copolymers, polyvinyl acetates and/or acrylonitrile-butadiene copolymers.

In order to achieve specific application-related performance characteristics of heat-sensitive recording materials, preferably of self-adhesive heat-sensitive recording materials, especially of self-adhesive labels, the binder is preferably present in crosslinked form in the heat-sensitive layer, with the optimum degree of crosslinking of the binder being achieved in the drying step of the coating process in the presence of a crosslinking agent (crosslinker).

The crosslinkers may be polyvalent aldehydes, such as glyoxal, dialdehyde starch, glutaraldehyde, etc., possibly mixed with boron salts (borax), may be salts or esters of glyoxylic acid, may be crosslinkers based on ammonium zirconium carbonate, may be polyamidoamine epichlorohydrin resins (PAE resins), may be adipic acid dihydrazide (AHD), boric acid or salts thereof, or others.

Self-crosslinking binders, such as specially modified polyvinyl alcohols or acrylates, allow crosslinking without any crosslinker at all, thanks to the reactive, crosslinkable groups that are already incorporated in the binder polymer.

The crosslinker is preferably present in an amount of from about 0.05 to about 0.5, especially preferably in an amount of from about 0.1 to about 0.2, in relation to the crosslinkable binder component from the heat-sensitive layer.

In a further preferred embodiment, at least one release agent (non-stick agent) or lubricant is present in the heat-sensitive colour-forming layer. These agents are preferably fatty acid metal salts, for example zinc stearate or calcium stearate, or also behenate salts, synthetic waxes, for example in the form of fatty acid amides, for example stearic acid amide and behenic acid amide, fatty acid alkanolamides, for example stearic acid methylolamide, paraffin waxes with different melting points, ester waxes of different molecular weights, ethylene waxes, propylene waxes of different hardnesses and/or natural waxes, for example carnauba wax or montan wax.

The release agent is preferably present in an amount of from about 1 to about 10, especially preferably in an amount of from about 3 to about 6, in relation to the total solids content of the heat-sensitive layer.

In another preferred embodiment, the heat-sensitive colour-forming layer contains pigments. One of the advantages of using pigments is that they can fix the chemical melt produced in the thermal printing process on their surface. Pigments can also be used to control the surface whiteness and opacity of the heat-sensitive colour-forming layer and its printability with conventional printing inks. Lastly, pigments have an “extender function”, for example for the relatively costly colouring functional chemicals.

Especially suitable pigments are inorganic pigments, both of synthetic and natural origin, preferably clays, precipitated or natural calcium carbonates, aluminium oxides, aluminium hydroxides, silicas, precipitated and fumed silicas (for example Aerodisp® types), diatomaceous earths, magnesium carbonates, talc, but also organic pigments such as hollow pigments with a styrene/acrylate copolymer wall or urea/formaldehyde condensation polymers. These can be used alone or in any mixture.

The pigments are preferably present in an amount of from about 20 to about 50% by weight, especially preferably in an amount of from about 30 to about 40% by weight, in relation to the total solids content of the heat-sensitive layer.

To control the surface whiteness of the heat-sensitive recording material, optical brighteners (whiteners) can be incorporated in the heat-sensitive colour-forming layer. These are preferably stilbene derivatives.

In order to improve certain coating properties, it is preferable in individual cases to add further constituents, especially rheological aids such as thickeners and/or surfactants, to the mandatory constituents of the heat-sensitive recording material.

The applied area density of the (dry) heat-sensitive layer is preferably from about 1 to about 10 g/m², preferably from about 3 to about 5 g/m².

The heat-sensitive recording material described above can be obtained by known production methods.

It is advantageous if the dried heat-sensitive colour-forming layer is subjected to a smoothing measure. Here, it is advantageous to set the Bekk smoothness, measured according to ISO 5627: 1995-03, to about 100 to about 1000 sec., preferably to about 250 to about 600 sec.

The surface roughness (PPS) according to ISO 8791-4: 2008-05 is in the range of from about 0.50 to about 2.50 μm, preferably in the range of between 1.00 and 2.00 μm.

The heat-sensitive recording material is preferably phenol-free and well suited for applications in which a thermal paper is equipped on the rear face with an adhesive layer which is printed using the direct thermal method and must ensure a long shelf life, even when stored under harsh ambient conditions, with regard to the specified writing performance, background whiteness and contrast values.

With regard to the choice of adhesive applied to the rear face, the present invention is not subject to any significant limitations. Both adhesives that are tacky at room temperature and adhesives that become tacky only after activation (for example by heat) are suitable. Both permanently adhesive and removable adhesives can be used. The technology used to apply the adhesive mass to the rear face of the heat-sensitive recording material also does not limit the scope of the invention in any way. Aqueous dispersions of the adhesive or adhesives dissolved or suspended in organic media as well as adhesives applied in a molten state (hotmelt adhesives) can be used.

The applied area density of the dried adhesive layer is preferably from about 10 to about 150 g/m², preferably from about 15 to about 30 g/m².

The use according to the invention is further preferably characterised in that the relative print contrast of the papers stored in accordance with the migration test equals at least 70% and/or the image density at a value of ≥1.20 o.d. units of the papers stored in accordance with the migration test equals at least 35% of the value of the image density before storage.

The use according to the invention is additionally preferably characterised in that the relative print contrast of the papers stored in accordance with the migration test equals at least 70% and/or the area-based colour developer quantity (mg/m²) in papers stored in accordance with the migration test equals at least 30% of the developer quantity before storage.

The use according to the invention is further preferably characterised in that the image density at a value of ≥1.20 o.d. units of the papers stored in accordance with the migration test equals at least 35% of the value of the image density before storage and/or the area-based colour developer quantity (mg/m²) in papers stored in accordance with the migration test equals at least 30% of the developer quantity before storage.

In a further preferred embodiment, the use according to the invention is characterised in that the relative print contrast of the papers stored in accordance with the migration test equals at least 70%, preferably at least 80%.

In a further preferred embodiment, the use according to the invention is characterised in that the image density at a value of ≥1.20 o.d. units of the papers stored in accordance with the migration test is at least 40%, preferably at least 50%, of the value of the image density before storage.

In a further preferred embodiment, the use according to the invention is characterised in that the area-based colour developer quantity (mg/m²) in papers stored in accordance with the migration test equals at least 25%, preferably at least 30%, of the developer quantity before storage.

To summarise, it can be asserted that it has surprisingly been shown that, by using a specific polymorphic modification of the phenol-free beta form of the colour developer, it is possible to obtain self-adhesive heat-sensitive recording materials, especially thermal labels, which are distinguished by outstanding durability of the surface whiteness, a high writing performance and good contrast values of the printed image during thermal printing after long-term storage under harsh ambient conditions.

### EXAMPLES

The low-melting polymorphic modification of Pergafast 201® (α-polymorph, alpha form from Table 1) was used as a comparative developer.

### Finishing of the Thermal Papers as Self-Adhesive Labels

### Application of an Adhesive Layer to the Rear Face of an A4 Sheet

a) The adhesive dispersion was applied using a doctor blade to the rear face of an A4 paper (thermal paper) carrying the heat-sensitive layer on the front face and was dried at max. 70° C. using a hot air gun. To protect the adhesive layer during further processing, a siliconised release paper was laminated onto the adhesive layer, avoiding air pockets and wrinkles.
b) In the case of an “adhesive-liner sandwich”, consisting of a thin adhesive layer between two release papers, after removing one of the two liner papers, the adhesive layer (sticky side) was laminated onto the rear face of the A4 thermal paper, avoiding air pockets and wrinkles.

It is irrelevant whether, during the production of the thermal label, the adhesive layer is applied first and then the heat-sensitive recording layer is applied to the opposite face carrying the adhesive layer.

An aqueous coating suspension to form the heat-sensitive colour-forming layer of a heat-sensitive recording paper was applied on a laboratory scale by means of a doctor bar to the coat side of a 72 g/m² paper precoated with a pigment coating.

The composition of the pigmented precoat is not critical. Usually, this coating consists of calcined kaolin and a binder based on styrene-butadiene and/or starch. It is also common to use organic (hollow sphere) pigments, possibly mixed with inorganic pigments. The application amount of this pigmented layer is between about 3 and 10 g/m².

After drying of the aqueous application suspension of the heat-sensitive coating mass, a thermal recording sheet was obtained. The application amount of the heat-sensitive colour-forming layer was between 3.8 and 4.3 g/m². A composite material suitable for use as a thermal label was obtained by applying, according to one of the methods a) or b) described above, an adhesive layer to the opposite substrate face (rear face) carrying the heat-sensitive layer. The application amount of the adhesive was about 20 g/m².

Based on the above information, a heat-sensitive recording material or thermal paper was produced, with the following formulations of aqueous application suspensions having been used to form a composite image on a carrier substrate as described above.

### Preparation of the Dispersions (in Each Case for 1 Part by Weight) for the Application Suspensions:

Aqueous dispersion A (colour former dispersion) was prepared by grinding 20 parts by weight of 3-N-n-dibutylamine-6-methyl-7-anilinofluorane (ODB-2) with 33 parts by weight of a 15% aqueous solution of Ghosenex™ L-3266 (sulfonated polyvinyl alcohol, Nippon Ghosei) in a bead mill.

The aqueous dispersion B (colour developer dispersion) was prepared by grinding 40 parts by weight of the colour developer together with 66 parts by weight of a 15% aqueous solution of Ghosenex™ L-3266 in the bead mill.

Aqueous dispersion C (sensitiser dispersion) was prepared by grinding 40 parts by weight of sensitising agent with 33 parts by weight of a 15% aqueous solution of Ghosenex™ L-3266 in a bead mill.

All dispersions produced by grinding had a mean grain size D(4,3) of from 0.80 to 1.20 μm. The grain size distribution of the dispersions was measured by laser diffraction using a Coulter LS230 instrument from Beckman Coulter.

Dispersion D (lubricant dispersion) was a 20% zinc stearate dispersion consisting of 9 parts by weight Zn stearate, 1 part by weight Ghosenex™ L-3266, and 40 parts water.

Pigment P was a 56% PCC suspension (PCC=precipitated calcium carbonate).

The binder consisted of a 10% aqueous polyvinyl alcohol solution (Mowiol 28 to 99, Kuraray Europe).

The crosslinker V was a 42% aqueous solution of a glyoxal.

Crosslinker V was a 42% aqueous solution of a glyoxal-borax based crosslinker (Cartabond TSI®, Clariant).

A 31% aqueous solution of a tetrasulfo-stilbene compound, Blankophor® PT (Blankophor), was used as an optical brightener.

The heat-sensitive application suspension was prepared by mixing, with stirring, 1.6 parts A, 1.5 parts B, 1.5 parts C, 70 parts D, 188 parts pigment P, 400 parts binder solution, 4 parts optical brightener and 14 parts crosslinker solution V (all parts by weight), taking into account the order of incorporation of B, D, C, P, A, binder, optical brightener and V, and was brought to a solids content of about 25% with water.

The following commercially available adhesives were used to produce self-adhesive thermal labels:
R5000N (Avery Fasson) is a removable acrylate-based adhesive.
S2200 (Avery Fasson) is a permanent hotmelt adhesive for deep-freeze applications based on styrene-isoprene and PVC copolymers.

Technomelt PS 8746 (Henkel) is a permanent hotmelt adhesive based on synthetic rubber.

The heat-sensitive recording materials thus converted into self-adhesive thermal labels were tested/evaluated as presented below (Table 2).

### (1) Surface Whiteness (Whiteness)

The whiteness of the face carrying the heat-sensitive coating (=top face) of the thermal label papers was determined according to ISO 2470 using an Elrepho 3000 spectrophotometer.

The % decrease in whiteness after storage was determined using Eq. 1

$$\% remaining whiteness = ( \frac{whiteness after storage}{whiteness before storage} ) * 100 \qquad ( Eq . 1 )$$

### (2) Dynamic Colour Density:

The thermal papers (strips 6 cm wide) were thermally printed using the Atlantek 200 test printer (Atlantek, USA) with a Kyocera print bar of 200 dpi and 560 ohms at an applied voltage of 20.6 V and a pulse width determined by pre-trials with a chequerboard pattern with no energy graduations, the pulse width having been selected to achieve an optical density of 1.20±0.05. The area of one square of the print sample corresponded to 80×80 dots. The image density (optical density, o.d.) was measured using a SpectroEye densitometer from X-Rite, with the measurement uncertainty of the o.d. values being estimated at ≤2%. The scatter of the % values calculated according to (Eq. 2) was ≤+2 percentage points.

### (3) Relative Print Contrast

The relative contrast was calculated using the value of the optical density of a thermally printed region (oDₛ) and the optical density of a non-printed region (oD_{w}) according to Eq. (2) (s=black region, w=white region):

$$\% rel . contrast = ( \frac{oDs - oDw}{oDs} ) * 100 \qquad ( Eq . 2 )$$

### (4) Adhesive Migration Test for Thermal Label Papers

An A4 self-adhesive thermal label paper was divided lengthwise into three strips 6 cm wide. Two strips were stored for four weeks between two glass plates at 60° C., a pressure of 1350 N/m², a relative humidity of 50% and in the absence of light, while one strip was printed and measured according to (2) (o.d., image density before storage).

After storage and once brought to room temperature, the two strips were printed according to (2), and the optical density was determined, averaged and set in relation to the analogously determined image density values of the non-stored sample according to the formula (Eq. 2).

$$\% remaining image density = ( \frac{image density after storage}{image density before storage} ) * 100 \qquad ( Eq . 3 )$$

Table 2 summarises the evaluation of the recording materials produced.

### (5) Quantitative Determination of the Area Concentration of the Colour Former and Colour Developer (Table 3):

The coat components (colour former and colour developer) were quantified after HPLC separation with an Agilent 1200 series HPLC instrument with DAD detector.

Sample preparation: 2 circular areas (area 0.000402 m²) were punched out of the paper sample using a punch. The paper samples were extracted with 3 ml acetonitrile (HPLC quality) in an ultrasonic bath for 30 minutes. If the extract was turbid, it was filtered through a 0.45 μm filter. As standard, 10 μl were injected.

HPLC separation of the ingredients: Using an autosampler, the above extract was applied to the separation column (Synergi 4 μm Fusion RP80A, 250×3 mm, preceded by SecurityGuard pre-column with cartridge 4×2 mm) and eluted with the flow agent acetonitrile:H₂O with 0.1% formic acid (60:40 parts by volume) with an acetonitrile (with 0.1% formic acid) gradient.

The quantitative evaluation of the chromatograms was carried out via the area comparison of the sample peaks assigned via t times with a standard curve determined via the reference sample. The measurement error in the HPLC quantification was +2%.

From the above examples, it can be seen that the heat-sensitive self-adhesive label of the present invention exhibits, especially, the following advantageous properties (Tables 2 and 3):
(1) The whiteness of the unprinted and stored self-adhesive thermal label papers with the beta-form as colour developer is higher than that of the comparison samples with alternative polymorphic modifications (alpha form, Pergafast 201).
(2) The use of the beta form as colour developer results in self-adhesive thermal labels that, after long-term storage under harsh conditions, demonstrate significantly higher print densities than those in which a PF 201 is used as colour developer.
(3) From (1) and (2), there is a clear advantage in terms of contrast of the performance properties after storage for the thermal label papers with beta form as colour developer.
(4) The chemical resistance to migratable constituents from the adhesive layer is significantly greater than in the comparative examples (Table 3).
(5) With the use of the beta form, a self-adhesive thermal label of high quality in important application-related aspects can be obtained.

TABLE 2

| | | Whiteness (%)* | | | Image density* | | | Relative print | |
|---|---|---|---|---|---|---|---|---|---|
| | | | | % rem. | | | % | contrast (%)* | |
| Adhesive | Developer^{‡} | before | after | whiteness | before | after | o.d. | before | after |
| R5000 | Alpha form | 93 | 74 | 80 | 1.23 | 0.37 | 30 | 95 | 63 |
| | Beta form | 94 | 77 | 82 | 1.25 | 0.74 | 59 | 96 | 89 |
| S2200 | Alpha Form | 89 | 67 | 75 | 1.23 | 0.40 | 33 | 94 | 68 |
| | Beta form | 90 | 74 | 82 | 1.23 | 0.71 | 58 | 95 | 88 |
| Technomelt | Alpha Form | 93 | 67 | 72 | 1.23 | 0.39 | 32 | 95 | 68 |
| | Beta form | 94 | 74 | 79 | 1.22 | 0.65 | 53 | 95 | 85 |

^{‡}corresp. to Table 1
*corresp. to Eq. 1, Eq. 2 and Eq. 3

TABLE 3

| | | Alpha or beta form (mg/m²) | | | ODB-2 (mg/m²) | | |
|---|---|---|---|---|---|---|---|
| Adhesive | Developer^{‡} | before | after | % rem. | before | after | % rem. |
| R5000 | Alpha form | 590 | 34 | 6 | 356 | 343 | 96 |
| | Beta form | 620 | 190 | 31 | 387 | 376 | 97 |
| S2200 | Alpha form | 512 | 96 | 19 | 363 | 358 | 99 |
| | Beta form | 589 | 250 | 42 | 371 | 357 | 96 |
| Technomelt | Alpha form | 510 | 105 | 21 | 368 | 349 | 95 |
| | Beta form | 559 | 218 | 39 | 393 | 385 | 98 |

^{‡}corresp. to Table 1

1. Use of N (p toluenesulfonyl) N′ (3 p toluenesulfonyl oxy phenyl)urea with an X ray diffraction pattern with Bragg angles (2θ/CuKα) of 10.3, 11.0, 12.9, 13.2, 15.4, 17.1, 18.0, 18.2, 19.4, 20.0, 20.7, 21.2, 23.0, 24.9, 25.3, 26.5, 26.8, 27.5, 30.7, 32.7 as a colour developer in a heat sensitive recording material comprising a carrier substrate, a heat sensitive colour forming layer which is applied to one face of the carrier substrate and which contains at least one non phenolic colour developer and at least one colour former, and an adhesive layer and/or a coating in order to allow rear face printing using conventional printing methods on the carrier substrate face facing away from the heat sensitive colour forming layer, so as to limit the loss of image density and/or the relative print contrast and/or the reduction of the area based colour developer quantity, wherein, with a value of ≥1.20 optical density units for the heat sensitive recording material stored in accordance with the migration test defined in the description, the image density equals at least 35% of the value of the image density prior to storage and/or the relative print contrast of the heat sensitive recording material stored in accordance with the migration test equals at least 70% of the value of the relative print contrast prior to storage and/or the area based colour developer quantity of the heat sensitive recording material stored in accordance with the migration test equals at least 30% of the area based colour developer quantity prior to storage.

2. The method according to claim 16, characterised in that the carrier substrate comprises paper, synthetic paper and/or a plastic film.

3. The method according to claim 16, characterised in that the at least one colour former is a dye of the triphenylmethane type, of the fluoran type, of the azaphthalide type and/or of the fluorene type.

4. The method according to claim 16, characterised in that at least one further intermediate layer is present between the carrier substrate and the heat-sensitive layer and comprises organic hollow sphere pigments and/or calcined kaolins.

5. The method according to claim 16, characterised in that the colour former is present in an amount of from about 5 to about 30% by weight, in relation to the total solids content of the heat-sensitive layer.

6. The method according to claim 16, characterised in that the colour developer is present in an amount of from about 3 to about 35% by weight, in relation to the total solids content of the heat-sensitive layer.

7. The method according to claim 16, characterised in that the adhesive layer comprises at least one pressure-sensitive adhesive, comprised of rubber and/or acrylate, and/or comprises a heat-activatable adhesive.

8. The method according to claim 16, characterised in that the image density at a value of ≥1.20 optical density units of the heat-sensitive recording material stored in accordance with the migration test equals at least 35% of the value of the image density prior to storage and the relative print contrast of the heat-sensitive recording material stored in accordance with the migration test equals at least 70% of the value of the relative print contrast prior to storage and the area-based colour developer quantity of the heat-sensitive recording material stored in accordance with the migration test equals at least 30% of the area-based colour developer quantity prior to storage.

9. The method according to claim 16, characterised in that the image density at a value of ≥1.20 optical density units of the heat-sensitive recording material stored in accordance with the migration test equals at least 35% of the value of the image density prior to storage and the relative print contrast of the heat-sensitive recording material stored in accordance with the migration test equals at least 70% of the value of the relative print contrast prior to storage.

10. The method according to claim 16, characterised in that the relative print contrast of the heat-sensitive recording material stored in accordance with the migration test equals at least 70% of the value of the relative print contrast prior to storage and the area-based colour developer quantity (mg/m²) of the heat-sensitive recording material stored in accordance with the migration test equals at least 30% of the area-based colour developer quantity prior to storage.

11. The method according to claim 16, characterised in that the image density at a value of ≥1.20 optical density units of the heat-sensitive recording material stored in accordance with the migration test equals at least 35% of the value of the image density prior to storage and the area-based colour developer quantity of the heat-sensitive recording material stored in accordance with the migration test equals at least 30% of the area-based colour developer quantity prior to storage.

12. The method according to claim 16, characterised in that the image density at a value of ≥1.20 optical density units of the heat-sensitive recording material stored in accordance with the migration test equals at least 40%, of the value of the image density prior to storage.

13. The method according to claim 16, characterised in that the relative print contrast of the heat-sensitive recording material stored in accordance with the migration test equals at least 70%, of the value of the relative print contrast prior to storage.

14. The method according to claim 16, characterised in that the area-based colour developer quantity of the heat-sensitive recording material stored in accordance with the migration test equals at least 30% of the area-based colour developer quantity prior to storage.

15. The method according to claim 16, characterised in that the heat-sensitive recording material has an adhesive layer on the carrier substrate face facing away from the heat-sensitive colour-forming layer.

16. A method of limiting at least one of the following three features:
a) the loss of image density,
b) the loss of relative print contrast, and/or
c) the reduction of the area-based colour developer quantity;
wherein, with a value of ≥1.20 optical density units for the heat-sensitive recording material stored in accordance with the migration test defined in the description, at least one of the following three features is fulfilled:
d) the image density equals at least 35% of the value of the image density prior to storage,
e) the relative print contrast of the heat-sensitive recording material stored in accordance with the migration test equals at least 70% of the value of the relative print contrast prior to storage, and/or
f) the area-based colour developer quantity of the heat-sensitive recording material stored in accordance with the migration test equals at least 30% of the area-based colour developer quantity prior to storage;
wherein the method comprises N-(p-toluenesulfonyl)-N′-(3-p-toluenesulfonyl-oxy-phenyl)urea with an X-ray diffraction pattern with Bragg angles (2θ/CuKα) of 10.3, 11.0, 12.9, 13.2, 15.4, 17.1, 18.0, 18.2, 19.4, 20.0, 20.7, 21.2, 23.0, 24.9, 25.3, 26.5, 26.8, 27.5, 30.7, 32.7 as a colour developer in a heat-sensitive recording material comprising a carrier substrate, a heat-sensitive colour-forming layer which is applied to one face of the carrier substrate and which contains at least one of the following two features:
g) at least one non-phenolic colour developer and at least one colour former, and an adhesive layer, and/or
h) a coating in order to allow rear-face printing using conventional printing methods on the carrier substrate face facing away from the heat-sensitive colour-forming layer.
